(19) United States
(12) Patent Application Publication
(10) Pub. No.: US 2024/0424452 A1
(43) Pub. Date: Dec. 26, 2024

(54) POROUS MEMBRANE PREPARED BY STRETCHING HEAT-TREATED SHEET CONTAINING POLYTETRAFLUOROETHYLENE AND/OR MODIFIED POLYTETRAFLUOROETHYLENE

(71) Applicant: CHEMOURS-MITSUI FLUOROPRODUCTS CO., LTD., MINATO-KU, TOKYO (JP)

(72) Inventors: KEN MIURA, SHIZUOKA (JP); SHUNNOSUKE FUKAZAWA, SHIZUOKA (JP); KOHEI MIYAMAE, SHIZUOKA (JP); HARUKA ONO, SHIZUOKA (JP); SHUNICHI SHIMATANI, SHIZUOKA (JP); KAZUO KONABE, SHIZUOKA (JP)

(73) Assignee: CHEMOURS-MITSUI FLUOROPRODUCTS CO., LTD., MINATO-KU, TOKYO, JP (JP)

(21) Appl. No.: 18/274,777

(22) PCT Filed: Jan. 31, 2022
(86) PCT No.: PCT/US2022/014552

§ 371 Date: Jul. 28, 2023

(30) Foreign Application Priority Data
Feb. 1, 2021 (JP) 2021-014316

(51) Int. Cl. B01D 71/36; B29C 48/00; B29K 27/18

(52) U.S. Cl. CPC B01D 71/36; B29C 48/0018; B01D 2323/081; B01D 2323/62; B29K 2027/18

(57) ABSTRACT

The present invention provides: a porous membrane comprising polytetrafluoroethylene and/or modified polytetrafluoroethylene, which has a small pore diameter, is difficult to break, and is resistant to an external force such as penetration and the like; and a manufacturing method of same. Further provided is a porous membrane comprising polytetrafluoroethylene and/or modified polytetrafluoroethylene, where the bubble point due to isopropyl alcohol in accordance with JIS K3832 is 500 kPa or more, a numerical value obtained by dividing the maximum force until a needle penetrates by the thickness of a test piece is 200 mN/μm or more, based on a needle penetration strength test in accordance with JIS Z1707, the percentage of pore opening portions in a surface image by electron microscopy is 10 to 30%, and the fiber thickness is 250 nm or more.

### CROSS REFERENCE TO RELATED APPLICATIONS

This application is a national filing under 35 U.S.C. 371 of International Application No. PCT/US2022/014552 filed Jan. 31, 2022 and claims the benefit of priority of Japanese Application No. 2021-014316 filed Feb. 1, 2021, the disclosure of which is incorporated herein by reference in its entirety.

### TECHNICAL FIELD

The present invention relates to a porous membrane comprising polytetrafluoroethylene and/or modified polytetrafluoroethylene having a small pore diameter and high strength and that is particularly difficult to tear and break; and a manufacturing method of same.

### BACKGROUND TECHNOLOGY

Polytetrafluoroethylene (PTFE) has been utilized in a variety of fields due to its excellent heat resistance, chemical resistance, water repellency, weather resistance, and low dielectric constant. Many PTFE porous membranes with various properties and manufacturing methods thereof have been invented to provide easier porosification of the PTFE by stretching.

PTFE porous membranes have high water repellency and are therefore used in applications such as clothing having waterproof permeability, vent filters for adjusting the internal pressure of automobile parts, and waterproof sound transmitting membranes of communication equipment and the like.

The waterproofing performance is indicated by a numerical value from water resistant pressure testing. For example, a membrane used in a 100 m waterproof cell phone or the like requires a water resistant pressure of 1 MPa. However, a membrane having a water resistant pressure of 1 MPa must have a pore diameter of tens of nanometers or less.

Furthermore, in the case of vent filters for adjusting the internal pressure of an automobile part, welding to the part that requires internal pressure adjustment is necessary, and strength to withstand welding is also required. Furthermore, there may be harsh conditions of a running automobile, such as dust, dirt, pebbles, and other foreign materials coming into contact with the membrane at high speed, thereby damaging the membrane and reducing waterproofing function. Therefore, the membrane may be provided with a protective cap or lid to provide a structure that prevents the foreign materials from coming into direct contact with the membrane. However, if emphasis is placed on automobile safety, this may be insufficient, and the membrane itself is also required to have high strength.

Furthermore, an external force applied to the membrane by agitation from a washing machine or the like during cleaning must be considered for ware with a waterproofing function, and the ware must also be difficult to break. Needless to say, film strength is also required in these fields.

As dustproof applications, PTFE porous membranes are used for filters for air cleaners or cleaners, bag filters for dust collection such as garbage incinerators, air filters for clean rooms for manufacturing semiconductors, and the like.

In addition, due to the pure nature of the PTFE, that is, because of the presence of little eluate, PTFE porous membranes have been used instead of conventional ultrafiltration membranes as the final filter in the manufacture of ultrapure water.

In addition, chemical resistance is excellent, therefore, use is also possible in filtration applications including etching solutions of circuit boards in corrosive liquids, organic solvents, or semiconductor manufacturing applications, and the like, applications such as collecting valuable materials in etching solutions, and the like.

In semiconductor manufacturing applications, there has been a recent increase in the degree of integration of the circuit. Therefore, PTFE porous membranes (having nano order pore diameters) capable of removing nano order fine particles in an etching solution are required because the presence of nano order fine particles in the etching solution allows the fine particles to remain on the wiring of the integrated circuit and causes a decrease in yield during the manufacture thereof. Such porous membranes must be strong enough to withstand filtration pressure and a filtrating operation.

Furthermore, applications of the PTFE porous membranes have attracted attention in the energy field, particularly in the manufacturing of hydrogen, which is alternative means to electricity for storing energy, and in the field of batteries and capacitors. Hydrogen is manufactured using electrolysis of water and the like, and a porous membrane is used as a separator by inserting between positive and negative electrodes under a redox reaction in a concentrated alkaline solution and at a high temperature. The electrode is not smooth and has some unevenness, and the membrane may also be damaged by a crystal material produced by an electrode reaction. Furthermore, the membrane is strongly restrained between the electrodes, therefore, the membrane can suffer damage similar to that caused by, for example, a needle-like foreign object pressed against the membrane. In the fields, the PTFE porous membrane is also required to have high strength.

Based on the aforementioned, the PTFE porous membrane must not only have a small pore diameter but also be difficult to tear and strong enough to resist breaking even when pressed by a needle-like object.

However, a PTFE porous membrane with a nano-order pore diameter with high strength is difficult to obtain.

Generally, PTFE porous membranes are often manufactured in the following steps.
1. A PTFE and an auxiliary agent (hydrocarbon based solvent or the like) are mixed.
2. The ratio (RR) of a cylinder cross sectional area/outlet cross sectional area is increased, after which shear (shear force) is applied to the PTFE by extrusion molding to obtain a sheet shaped or bead shaped extrudate during fiberization.
3. After the obtained extrudate is appropriately rolled into a sheet shape using a rolling machine (roller) or the like, the hydrocarbon based solvent is evaporated and removed.
4. The obtained sheet shaped product is stretched at a high temperature in an extrusion direction (hereinafter, also referred to as MD) and in a direction (hereinafter, also referred to as CD) orthogonal to the extrusion direction, after which a PTFE porous membrane is obtained by baking at a temperature higher than the melting point (342 to 343° C.) of the PTFE.

However, with such a general method, it is difficult to obtain a PTFE porous membrane having a small pore diameter and high strength and that is difficult to tear. This is considered to be because a stretching condition is a temperature condition below the melting point of PTFE (342 to 343° C.), which results in the generation of many fine fibers and prevents strength from increasing. Furthermore, PTFE stretches well below the melting point, the stretching ratio and the porosity increase, which is also considered to be a factor. Increasing the stretching ratio has an advantage of increasing tensile strength due to PTFE molecules being more strongly oriented but is often less resistant to tearing and the like.

Therefore, many methods have been proposed to manufacture a PTFE porous membrane by heating rolled and dried sheets above the melting point of PTFE in advance and then stretching the sheets. Even though heating is performed above the melting temperature, it may be referred to as stretching in a condition without being completely baked, or as semi-baked stretching. The method is known to be capable of producing a thick fiber and obtaining a membrane with a small pore diameter.

In Patent Document 1, a method for measuring the crystal heat of fusion of PTFE is specified, and a sheet is prepared using a resin with a heat of fusion of 32 J/g or more and less than 47.8 J/g. The sheet is then heated above the melting point, cooled, and then stretched to obtain a porous membrane with a porosity of 30% or more and a thickness of 50 μm or less. Resins with a heat of fusion of 32 J/g or more and less than 47.8 J/g mainly include commercially available low molecular weight resins or resins with a molecular weight that has been reduced by decomposing a commercially available resin with radiation or the like.

Moreover, in Patent Document 2, a PTFE coating membrane is formed by immersing a polyimide film in a PTFE dispersion, a PTFE membrane is obtained by repeating the drying/baking step, the PTFE membrane is peeled from the polyimide film, and the peeled PTFE membrane is sequentially stretched in the CD and MD. As a porous membrane obtained by this method, a needle penetration resistant membrane is prepared, having a characteristic value (49 to 147 mN/μm) where needle penetration strength is 5 to 15 gf/μm with regards to unit thickness.

In Patent Document 3, a stretched film with high filtration efficiency is prepared which has an asymmetric structure (in which the average pore diameter in the thickness direction is continuously reduced and the average pore diameter of the heating surface is 0.05 μm to 10 μm) and is used for the fine filtration of gases, liquids, and the like by sequentially stretching and thermally securing a partially sintered film (where in the process of manufacturing a PTFE porous membrane, a temperature gradient is formed in the thickness direction of the film by heating one side of the film prior to stretching) in the extrusion direction (MD) and the direction (CD) orthogonal to the extrusion direction.

However, in Patent Document 1, the molecular weight of the resin used is low, and low molecular weight is often inferior from the perspective of strength, as is the case with general plastic materials. Furthermore, although the needle stick strength is specified in Patent Document 2, it cannot be said that the strength is sufficient. In Patent Document 3, the strength of a very thin portion of a heated surface may be strong, but the membrane as a whole is not sufficiently strong.

Although these conventional technologies are effective in limited applications, these technologies have problems such as insufficient membrane strength in another application and the like, and are considered insufficient in providing a porous membrane with a small pore diameter that can be used under more severe conditions.

### PRIOR ART DOCUMENTS

### Patent Documents

[Patent Document 1] Japanese Patent Publication 5008850
[Patent Document 2] Japanese Unexamined Patent Application 2018-204006
[Patent Document 3] Japanese Patent Publication 4850814
[Patent Document 4] WO 2016/117565
[Patent Document 5] WO 2007/119829
[Patent Document 6] Japanese Patent Publication 5054007
[Patent Document 7] Japanese Unexamined Patent Application 2018-16697
[Patent Document 8] U.S. Pat. No. 3,037,953

### SUMMARY OF THE INVENTION

### Problem to be Resolved by the Invention

An object of the present invention is to provide: a novel porous membrane comprising polytetrafluoroethylene and/or modified polytetrafluoroethylene, which has a small pore diameter, is difficult to break, and is resistant to an external force such as penetration and the like.

### Means for Resolving Problems

The present invention provides a porous membrane comprising polytetrafluoroethylene and/or modified polytetrafluoroethylene, where the bubble point due to isopropyl alcohol in accordance with JIS K3832 is 500 kPa or more, a numerical value obtained by dividing the maximum force until a needle penetrates by the thickness of a test piece is 200 mN/μm or more, based on a needle penetration strength test in accordance with JIS Z1707, the percentage of pore opening portions in a surface image by electron microscopy is 10 to 30%, and fiber thickness is 250 nm or more.

A preferred aspect of the present invention is the porous membrane comprising polytetrafluoroethylene and/or modified polytetrafluoroethylene, wherein the polytetrafluoroethylene and/or modified polytetrafluoroethylene has a heat of fusion of less than 32 J/g at 296 to 343° C. using a differential scanning calorimeter when, in addition to the above, polytetrafluoroethylene and/or modified polytetrafluoroethylene resin is heated to 365° C. at a rate of 10° C./min, cooled to 330° C. at a rate of −10° C./min, cooled from 330° C. to 305° C. at a rate of −1° C./min, cooled from 305° C. to 245° C. at a rate of −10° C./min, and then heated to 365° C. at a rate of 10° C./min, where the bubble point is 600 kPa or more, and the numerical value obtained by dividing the maximum force until a needle penetrates by the thickness of a test piece is 250 mN/μm or more, based on a needle penetration strength test.

The present invention also provides a method of manufacturing the porous membrane comprising polytetrafluoroethylene and/or modified polytetrafluoroethylene according to claim 1 or 2, including:
1. a step of obtaining a sheet or coating film comprising polytetrafluoroethylene and/or modified polytetrafluoroethylene, which has not been heat treated at 250° C. or higher; 2. a step of securing and heat treating the sheet or coating film such that the ratio (Δ/ΔH0) of the following crystal heat of fusion (ΔH) and (ΔH0) is 1.0 to 2.0;
(Where ΔH0 is a crystal heat of fusion between 295 and 360° C. when the sheet or coating film comprising polytetrafluoroethylene and/or modified polytetrafluoroethylene resin, which has not been heat treated at 250° C. or higher, is heated for 20 minutes at 360° C., and then the sheet or coating film obtained by cooling at room temperature is increased in temperature to 380° C. at a rate of 10° C./min; and ΔH is a crystal heat of fusion between 295 and 360° C. when the sheet or coating film comprising polytetrafluoroethylene and/or modified polytetrafluoroethylene, which has not been heat treated at 250° C. or higher, is heat treated and then increased in temperature to 380° C. at a rate of 10° C./min); and 3. a step of stretching the heat-treated sheet or coating film in one direction and then sequentially stretching in a second direction orthogonal to the first direction.

Herein, a preferred aspect of the present invention is the method of manufacturing a porous membrane, where the heat treating step is a step of securing and heat treating the sheet or the coating film such that the ratio (ΔH/ΔH0) of the crystal melting heat quantities (ΔH) and (ΔH0) is 1.2 to 1.8.

Furthermore, a preferred aspect of the present invention is also the method of manufacturing a porous membrane, where the heat treated sheet is stretched in an extrusion direction and then sequentially stretched in an orthogonal direction.

Furthermore, a preferred aspect of the present invention is the method of manufacturing a porous membrane, where the sheet that has not been heat treated at 250° C. or higher is a sheet obtained by rolling a sheet shaped or bead shaped extrudate obtained by mixing polytetrafluoroethylene and/or modified polytetrafluoroethylene with a hydrocarbon based solvent having a boiling point of 150 to 290° C. and then extruding at RR 35 to 120 and a molding temperature of room temperature to 120° C. using an extruder.

A preferred aspect of the present invention is also the method of manufacturing a porous membrane, where the coating film that has not been heat treated at 250° C. or higher is a coating film obtained by coating a dispersion of polytetrafluoroethylene and/or modified polytetrafluoroethylene with a solid fraction concentration of 5 to 75 mass %, comprising a surfactant, film forming agent, and thickening agent onto a flat plate having a heat resistance of 400° C. or higher such that the thickness after drying is 1 to 50 μm, and then drying for 10 to 20 minutes at 100 to 150° C.

### Effect of the Invention

The present invention can be used as a separator or part of a separator in a fuel cell, capacitor, lithium battery, and the like, and can be used as a part of a separator for physically separating various positive and negative electrodes, in addition to waterproof sound transmitting applications for communication equipment requiring high water resistance and high strength, filtration applications such as vent filters for automobiles, etching solutions of circuit boards in corrosive liquids, organic solvents, or semiconductor manufacturing applications, and the like, applications such as collecting valuable materials in etching solutions, and the like.

### BRIEF DESCRIPTION OF THE DRAWINGS

FIG. 1 is an electron microphotograph (magnification: 10,000 times) of a surface of a PTFE porous membrane of Example 2.

FIG. 2 is a binarized photograph (magnification: 10,000 times) of the surface of the PTFE porous membrane of Example 2.

FIG. 3 is an electron microphotograph (magnification: 5000 times) of a surface of a PTFE porous membrane of Comparative Example 2.

FIG. 4 is a binarized photograph (magnification: 5000 times) of the surface of the PTFE porous membrane of Comparative Example 2.

### DESCRIPTION OF THE PREFERRED EMBODIMENTS

PTFE forming a porous membrane of the present invention may alternatively be modified PTFE that is copolymerizable with tetrafluoroethylene (TFE) and modified by less than 1 wt. % within a range that does not impair a property of PTFE. Examples of the modified PTFE can include copolymers of TFE described in Patent Document 5 and a trace amount of a monomer other than the TFE. More specific examples include copolymers of tetrafluoroethylene and at least one type of monomer that is copolymerizable with the tetrafluoroethylene, selected from less than 1 wt. % of hexafluoropropylene, perfluoro (alkyl vinyl ether), fluoroalkylethylene, and chlorotrifluoroethylene, which are copolymers that do not have melt moldability.

The PTFE and/or modified PTFE used in the present invention refers to PTFE with a high molecular weight when the crystal heat of fusion of less than 32 J/g at 296 to 343° C. obtained by using a differential scanning calorimeter when heated to 365° C. at a rate of 10° C./min, cooled to 330° C. at a rate of −10° C./min, cooled from 330° C. to 305° C. at a rate of −1/° C., cooled from 305° C. to 245° C. at a rate of −10° C./min, and then heated to 365° C. at a rate of 10° C./min, and is more preferably due to being capable of obtaining a high strength PTFE stretched membrane, in other words, PTFE porous membrane having high needle penetration strength. The PTFE and/or modified PTFE of the present application can also achieve higher mechanical strength as the molecular weight increases, similar to a general purpose plastic material.

The molecular weight of the PTFE or modified PTFE correlates with the standard specific gravity (SSG) in accordance with ASTM D4895, and the SSG of the PTFE or modified PTFE of the present invention is 2.19 or less, preferably 2.18 or less, and more preferably 2.16 or less, which is suitable for preparing a porous membrane with high strength.

Examples of the resins that can be used include: 660J, 650J, and modified polytetrafluoroethylene with a high molecular weight manufactured by Chemours-Mitsui Fluoroproducts Co., Ltd.; F106 and F104 manufactured by Daikin Industries, Ltd.; CD123E and CD145E manufactured by AGC Inc.; and the like.

The porous membrane comprising PTFE or modified PTFE of the present invention satisfies all of the following requirements:
the bubble point due to isopropyl alcohol (IPA) in accordance with JIS K3832 is 500 kPa or more,
a numerical value obtained by dividing the maximum force until a needle penetrates by the thickness of a test piece is 200 mN/μm or more, based on a needle penetration strength test in accordance with JIS Z1707,
the percentage of pore opening portions is 10 to 30%, and
fiber thickness is 250 nm or more.

The bubble point of the porous membrane of the present invention due to isopropyl alcohol (IPA) in accordance to JIS K3832 is 500 kPa or more, and preferably 600 kPa or more. A bubble point of 500 kPa or more indicates that the pore diameter of the PTFE porous membrane is a small pore diameter where nano-order particles can be removed.

In general, the maximum pore diameter of the PTFE porous membrane is calculated using the bubble point and the following equation.

$$Maximum pore diameter ( diameter : nm ) of PTFE porous membrane = 4 \times γ \times cos θ / P \times {10}^{9}$$

$$γ : IPA surface tension ( Pa \cdot m )$$

$$θ : Contact angle ( θ = 0 ) between IPA and porous membrane$$

$$P : Bubble point pressure ( Pa )$$

If the bubble point is 500 kPa, the maximum pore diameter calculated by the aforementioned equation is approximately 146 nm. However, the PTFE porous membrane has a large number of pore diameters of 146 nm or less, and therefore, particles of tens of nanometers can be captured upon filtration of the liquid. In general, when the bubble point is less than 400 kPa, removing nanoparticles of a nano order is difficult and waterproofing also deteriorates, which is not preferable.

The PTFE porous membrane of the present invention has a bubble point of 500 kPa or more, and therefore, the pore diameter of the porous membrane is small. Furthermore, the PTFE porous membrane of the present invention has high strength, and therefore does not tear even under a water pressure of approximately 100 m in vent filter and waterproof sound transmission applications and does not cause water leaking.

With the PTFE porous membrane of the present invention, the numerical value obtained by dividing the maximum force until a needle penetrates by the thickness of a test piece is 200 mN/μm or more, in a needle penetration strength test in accordance with JIS Z1707. The needle penetration strength test in accordance with JIS Z1707 is one physical property required for vent filter and battery separator applications, and is an indicator of the resistance to tearing and breaking of the porous membrane more so than a physical property value such as tensile strength and the like. Specifically, in the present invention, a semicircular needle with a diameter of 1.0 mm and a tip end shaped radius of 0.5 mm as specified in JIS Z1707 is made to penetrate at a testing rate of 50±5 mm/min, and the numerical value (needle penetration strength) obtained by dividing the maximum force (mN) until the needle penetrates by the thickness (μm) of the test piece is measured. A thicker membrane thickness increases the needle penetration strength, and therefore, the present invention specifies the strength per unit thickness in order to provide a thin membrane that is difficult to break.

The needle penetration strength of the present invention is 200 mN/μm or more, preferably 250 mN/μm or more, and more preferably 300 mN/μm or more.

Furthermore, according to the aforementioned Patent Document 2, the needle penetration strength is described as being 49 to 146 mN/μm, whereas the PTFE porous membrane of the present invention has a value of 200 mN/μm or more.

A pore opening portion (surface aperture ratio) of the PTFE porous membrane of the present invention is 10 to 30%. The surface aperture ratio is a physical property value related to air permeability of a porous membrane, and therefore is preferably higher. However, if the surface aperture ratio exceeds 30%, the needle penetration strength is reduced, which is not preferable, and if the surface aperture ratio is less than 10%, air permeability or liquid permeability (flow rate) is reduced (too low), which is not preferable.

A surface opening of the porous membrane of the present invention is formed by stretching to deform (break) a crystal portion produced by heat treating the PTFE sheet or coating film in the step of manufacturing the porous membrane. This is well known to a person of ordinary skill in the art of PTFE porous membranes. In a recrystallization process by heat treatment, the heating temperature, heating time, and the degree of crystal growth by slow cooling (degree of recrystallization) affect the aperture ratio. If heat treatment is insufficient, a porous membrane with a small pore diameter is difficult to obtain, and if heat treatment is excessive, deformation by stretching does not easily occur, and therefore, the membrane does not become porous.

The fiber thickness of the PTFE porous membrane of the present invention is 250 nm or more, and preferably 300 nm or more. If the fiber thickness is less than 250 nm, the strength of the PTFE porous membrane cannot be achieved (strength is reduced), which is not preferable.

Fibers in the PTFE porous membrane of the present invention are amorphous portions of PTFE (for example, portions where PTFE molecular chains are not regularly aligned while being regularly aligned in a crystal portion) generated by the heat treatment in the manufacturing process of the PTFE porous membrane described above. Moreover, the degree of entanglement of the PTFE molecular chains is high, and deformation (breaking) by a load such as a shear force during stretching, needle penetration, and the like, is difficult, which is considered to demonstrate excellent mechanical strength (needle penetration strength).

The fibers of the present invention are considered to be different from fibers with inferior mechanical strength (PTFE molecular chains) resulting from unraveling of the molecular chains in a PTFE particle, which is caused by stretching the sheets that have not been subjected to heat treatment of 250° C. or higher.

For the surface aperture ratio and fiber thickness of the PTFE porous membrane described above, a method can be used where a surface of the porous membrane is observed with an electron microscope and a dimension or area is directly measured from an image, but in the present invention, imaging software described in Patent Document 4 is preferably used. For example, using image analysis software: Image-Pro-Plus manufactured by Media Cybernetics, Inc., the porous membrane and openings are color-coded into black and white, and the ratio of each is automatically calculated. Thereby, the ratio of porous membrane to openings can be automatically calculated. The method is referred to as binarization processing. An electron microscope image used for binarization may be an image captured at a magnification where pores and the fiber structure can be discerned, and the magnification is not limited. However, an electron microscope image at a magnification of 5000 times to 20,000 times can be suitably used in a porous membrane with a small pore diameter where the bubble point of IPA of the present invention is 500 kPa or more.

The thickness of the PTFE porous membrane of the present invention is not particularly limited, but a polytetrafluoroethylene porous membrane with a thickness of 70 μm or less is a preferred embodiment of the present invention. A preferred range of the film thickness is 50 μm or less, and even more preferably 20 μm or less.

Next, a method of manufacturing a PTFE porous membrane will be described.

In the present invention, a heat treating and stretching method is used in which a pre-stretched sheet is heated higher than the melting point and then stretched, as described in Patent Document 1. In an ordinary method described above, where fibers are prepared by stretching below the melting point and then baking, the fiber diameter is thin, and the strength is insufficient. Moreover, a high needle penetration strength can not be achieved, which is an aim of the present invention.

As described above, stretching causes deformation of crystals and porosification, and in the heat treating and stretching method used in the present invention, a larger crystal heat of fusion of the PTFE used for manufacturing facilitates stretching and porosification. This is because PTFE is known to have a property of partially recrystallizing upon cooling even after being heated to melt crystals, and more crystals are present as the crystal heat of fusion increases.

If the amount of crystals is low, the membrane does not become porous even by stretching. On the other hand, if the amount of crystals is high, not only is a membrane with a small pore diameter difficult to obtain, but also a porous membrane with low needle penetration strength is produced. Regarding this point, Patent Document 1 also describes that a crystal heat of fusion of 32 J/g or more and less than 47 J/g is required even after heating higher than the melting point and then cooling.

However, a resin having the heat of fusion has a low molecular weight, and thus a membrane with a high needle penetration strength is difficult to prepare.

In the present invention, a method was discovered where a membrane with a small pore diameter by stretching and a high needle penetration strength is prepared by setting heat treatment conditions within a specific range. Furthermore, when PTFE of less than 32 J/g is used, a membrane with higher needle penetration strength can be obtained.

Details of the method of manufacturing a PTFE porous membrane in the present invention are as follows.

The manufacturing method of the present invention has three major steps: 1. a step of obtaining a sheet or coating film comprising PTFE and/or modified PTFE that has not been heat-treated at 250° C. or higher; 2. a heat treating step; and 3. a stretching step.

First, 1. the step of obtaining a sheet or coating films comprising PTFE and/or modified PTFE that has not been heat treated at 250° C. or higher will be described, followed by 2. the heat treating step.

The method of obtaining a sheet or coating film comprising PTFE and/or modified PTFE is not particularly limited.

First, a method that is generally used in the technical field can be used to obtain PTFE and/or modified PTFE.

Furthermore, the method using the “sheet” is preferably a method described below based on a general method of manufacturing a PTFE porous membrane, where a polytetrafluoroethylene and/or modified polytetrafluoroethylene powder and a hydrocarbon based solvent having a boiling point of 150 to 290° C. are added and mixed, and then extruded at RR 35 to 120 using an extruder to obtain a sheet or bead shaped extrudate or the like, after which the extrudate is rolled to prepare a sheet shaped rolled product, and then the hydrocarbon based solvent is removed.

Examples of the hydrocarbon based solvents used in manufacturing the PTFE porous membrane according to the present invention include straight-chain saturated hydrocarbon based solvents and/or branched saturated hydrocarbon based solvents having a boiling point of 150 to 290° C. and having at least one type having 8 to 16 carbon atoms. Examples of the straight-chain saturated hydrocarbon based solvents include: naphtha (hydrocarbon based solvent comprising at least one type of straight-chain saturated hydrocarbon having 8 to 14 carbon atoms, boiling point: 150 to 180° C.); Norpar 13 (carbon atoms: 12 to 14, boiling point: 222 to 243° C.); Norpar 15 (carbon atoms: 9 to 16, boiling point: 255 to 279° C.), and the like. Examples of the branched saturated hydrocarbon based solvents include: Isoper G (carbon atoms: 9 to 12, boiling point 160 to 176° C.), Isoper H (carbon atoms: 10 to 13, boiling point 178 to 188° C.), and Isomper M (carbon atoms: 11 to 16, boiling point 223 to 254° C.), each manufactured by Exxon Mobil Corporation; Supersol FP25 (carbon atoms: 11 to 13, boiling point 150° C. or higher) manufactured by Idemitsu Kosan Co., Ltd.), and the like. Isomper M prevents evaporation of the solvent upon rolling, can be easily removed by heating, and is odorless, and is therefore preferable.

In order to facilitate extrusion molding, the hydrocarbon based solvent (preferably Isopar M manufactured by Exxon Mobil Corporation) is added in an amount of 16% wt. % to 22% wt. %, and preferably 18 wt. % to 20 wt. % to the PTFE from the perspective of ease of extrusion, mixed for 3 to 5 minutes, and then allowed to stand at 20° C. or higher for 12 hours or more. Thereafter, a resin is introduced into a cylindrical pressurizing device and pressurized in a cylinder, and air included in a resin powder and the hydrocarbon based solvent is driven out to obtain a cylindrical preform.

Next, using an extruder, cylindrical preform is extrusion molded at an RR of 35 to 120, preferably 50 to 120, and more preferably 50 to 80, a molding temperature of 40 to 60° C., and preferably 40 to 50° C., and a ram extrusion speed of 10 to 60 mm/min, and preferably 20 to 30 mm/min to obtain a sheet shaped extrudate, bead shaped extrudate, tube shaped extrudate, and the like. The tube shaped extrudate can be cut in a length direction by a blade and opened to obtain a sheet shape.

If the ram extrusion speed is less than 10 mm/min, productivity deteriorates, which is not preferable. If the extrusion speed exceeds 60 mm/min, it is difficult to increase the extrusion pressure or obtain a uniform extrudate, which is not preferable.

If the RR is less than 35, the strength of the extrudate decreases, which is not preferable because the PTFE primary particles are not fiberized without sufficient shearing (shear force) on the primary particles of the PTFE.

Moreover, as the RR increases, the extrusion pressure during extrusion molding increases. If the RR exceeds 120, a large molding machine is required, which is not preferable.

In addition, if the molding temperature is lower than room temperature, the compatibility between the hydrocarbon based solvent and the PTFE is inferior, while fluidity deteriorates, which is not preferable. If the molding temperature exceeds 120° C., the hydrocarbon based solvent evaporates too quickly, which is not preferable.

Two sets of rollers are used to roll the sheet shaped extrudate and the like in the MD to achieve a predetermined thickness. Rolling is performed such that the rolling thickness is 200 μm or less, preferably 100 μm or less, and more preferably even to 50 μm, but with this method, 50 to 100 μm is the limit.

Furthermore, Patent Document 6 introduces a method of adjusting the ratio of the tensile strength of a rolled sheet between the MD and CD by including a step of not only rolling an extruded sheet in the MD with a roller but also pulling the sheet still comprising an auxiliary agent in a direction orthogonal to the extrusion direction. In the present invention, the rolling method is not limited, and a similar method can be used, if necessary, to reduce the difference in strength between the MD and CD of the sheet before heat treatment. In other words, the extruded sheet is cut to an appropriate length, and then rolling in the MD is carried out. Subsequent rolling in the CD involves rotating the sheet rolled in the MD by 90 degrees with regards to the MD and then deforming in the CD. Rolling in the two directions can be used in combination to roll the sheet shaped extrudate and the like to a thickness of 400 μm or less, preferably 300 μm or less, and more preferably 200 μm or less in order to obtain a sheet shaped rolled product.

The hydrocarbon based solvent in the sheet shaped rolled product is evaporated and removed at 150° C. or higher, and preferably 200° C. or higher, for 5 minutes or more, and preferably 15 minutes or more to obtain a rolled sheet that has not been heat treated at 250° C. or higher.

Next, the sheet is heated at 360° C. for 20 minutes, cooled at room temperature, and then raised to 380° C. at a rate of 10° C./min, and the crystal heat of fusion between 295° C. and 360° C. at this time is measured, which is ΔH0. Next, the crystal heat of fusion is measured under the same conditions except that only the heating temperature and heating time are changed, and when this is set as ΔH, the heating temperature and heating time are determined such that the value of ΔH/ΔH0 is 1.0 to 2.0. The temperature of the heat treatment must be above the melting point of PTFE. The value of ΔH/ΔH0 is preferably between 1.2 and 1.8, and even more preferably between 1.2 and 1.6.

The heat treatment is performed by securing the sheet comprising PTFE and/or modified PTFE such that dimensions do not change.

The heat treating step is similarly applied to a heat treating step for a coating film described below.

Note that the rolled sheet obtained by the aforementioned method, which has not been heat treated at 250° C. or higher, can be continuously passed through a heating furnace to be heat treated within a range where ΔH/ΔH0 of 1.0 to 2.0. Furthermore, heat treatment is also possible in a high temperature dryer after cutting to a predetermined area. Although heat treating conditions cannot be generally specified because firing conditions vary depending on the type of resin, general PTFE or modified PTFE can be achieved by heating for approximately 30 to 500 seconds at a temperature that is from the melting point of the PTFE or modified PTFE to be used to 400° C., preferably 350° C. to 400° C., and more preferably 350° C. to 385° C. in order to make the ΔH/ΔH0 value within a range of 1.0 to 2.0.

Next, a method using a “coating film” will be described. The method is a method of applying a dispersion on a flat plate in accordance with Patent Document 7.

A method is preferred where a water-soluble polymer and organic solvent serving as a surfactant, film forming agent, and thickening agent are added to a dispersion with a solid fraction concentration of 5 to 75 mass %, and preferably 40 to 65 mass %, comprising polytetrafluoroethylene and/or modified polytetrafluoroethylene having an average particle size of 0.01 to 5.00 μm, preferably 0.10 to 1.00 μm, and more preferably 0.10 to 0.50 μm, which is then coated onto a 1 mm or more thick smooth plate having a heat resistance of 400° C. or higher, and heated to a temperature of 360° C. or higher after removing water content, cooled at room temperature after decomposing and removing an additive, and then peeled from the smooth plate to prepare a coating film.

The dispersion where the water-soluble polymer and organic solvent serving as a surfactant, film forming agent, and thickening agent are added preferably has a viscosity by a B-type viscometer (viscosity at 30 rpm using a No. 2 rotor) of 1 to 600 cps, more preferably 100 to 600 cps, and even more preferably 200 to 500 cps.

Examples of a surfactant to be added to the dispersion include: LEOCOL manufactured by Lion Specialty Chemicals Co., Ltd., TRITON and TERGITOL series manufactured by Dow Chemical Company, EMGULGEN manufactured by Kao Corporation, and other polyoxyethylene alkyl ether and polyoxyethylene alkyl phenyl ether-based nonionic surfactants; LIPAL manufactured by Lion Specialty Chemicals Co., Ltd., EMAL and PELEX manufactured by Kao Corporation, and other sulfosuccinate, alkyl ether sodium sulfonate salt, sulfuric acid mono-long chain alkyl-based anionic surfactants; LEOARL manufactured by Lion Specialty Chemicals Co., Ltd., OROTAN manufactured by Dow Chemical Company, and other polycarboxylate, acrylate-based polymeric surfactants; and the like. Examples of the film forming agent include polyamides, polyamide imides, acrylics, acetates, and other polymeric film forming agents, higher alcohols, ethers, and polymeric surfactants having a film forming effect, and the like. Examples of the thickening agent include water-soluble celluloses, solvent dispersing thickening agents, sodium alginate, casein, sodium caseinate, xanthan gums, polyacrylic acids, acrylic acid esters, and the like, which can be added.

Furthermore, a dispersing liquid immediately after polymerization may be used as the dispersion, but the dispersion is preferably a dispersing liquid concentrated and stabilized by known technology such as a method described in Patent Document 8 or the like. The concentration of the dispersion is preferably 5 to 75 mass %, and the concentration of the PTFE resin is preferably increased by concentrating to 40 to 70 mass %.

Furthermore, as described above, a resin with less than 32 J/g (medium/high molecular weight resin) described in Patent Document 1 is more preferable as the resin.

Next, the aforementioned surfactant, film-forming agent, water-soluble polymer as a thickening agent and organic solvent are added to the dispersion, which is then applied to a stainless steel plate, aluminum plate, polyimide film or glass plate having a heat resistance of 400° C. or higher, and then heated to approximately 100° C. to dry out water content. In the present invention, the coating method is not limited, but suitable methods to be used include: a method of spraying using a spray nozzle and drying out water content; a method of immersing a plate in a dispersion to which the aforementioned surfactant, film-forming agent, water-soluble polymer as a thickening agent and organic solvent are added, withdrawing the plate at a predetermined speed, and then drying; and the like. The coating thickness can be freely controlled by the viscosity of the dispersion, number of times sprayed, spraying amount, withdrawing speed, and the like. In a coating step, coating can also be continuously performed on a polyimide film or aluminum plate, and the speed and length of a furnace can be adjusted for production so as to remain in a hot air drying furnace for a long period of time. Furthermore, a target coating film can also be obtained by applying on a glass plate or aluminum plate with a predetermined area and then heat treating in a high temperature drying furnace.

Subsequently, an additive is decomposed and removed at a temperature of 360° C. or higher. When the heating temperature is low, the coating film is colored due to an influence of a carbonized additive, and therefore, heating is required until the coating film is completely white. The heating temperature varies depending on the type of additive, but heating must be performed at the melting point of the PTFE or modified PTFE used to 400° C., preferably 350 to 400° C., and more preferably 350 to 385° C. Furthermore, the heating time must be determined by confirming the degree of decomposition and removal, but heating is preferably performed for at least 20 minutes. After heating, cooling is performed at room temperature, and then a porous membrane is prepared by a stretching step. Note that the coating film cooled at room temperature has already been heated above the melting point, and therefore, heat treatment for heat treatment is not required again.

Note that under this condition, the coating film is considered to be completely baked and not a coating film in a heat treated condition, but in the present invention, any heat treatment is defined as heat treatment so long as ΔH/ΔH0=1.0 to 2.0 as a result of measuring ΔH and calculating a ratio with ΔH0.

A method of mixing a PTFE resin with a hydrocarbon based solvent, extruding, rolling, and drying to prepare a sheet and then heat treating the sheet, and a method of coating a dispersion of the PTFE resin to prepare a thin, porous membrane and then decomposing and removing an additive simultaneously with heat treatment to prepare a coating film are specifically introduced for preparing the heat-treated sheet or coating film used in the method of manufacturing a porous membrane comprising PTFE and/or modified PTFE of the present invention. In the present invention, preparing the heat-treated sheet or coating film is not limited, but the two methods are suitably used. With regards to heating means for further performing heat treatment, high temperature drying was introduced. However, the heating means is not limited thereto, and a method of heating with an infrared heater and then contacting a surface heated higher than the melting point, including a heating roller, can also be used in the present invention.

Finally, the 3. stretching step is described.

In the stretching step, the heat-treated sheet obtained as described above is stretched in one direction in an atmosphere of 150 to 320° C., and preferably 300° C., and then sequentially stretched in an orthogonal direction thereto to prepare a porous membrane.

In the method of stretching a material that has not undergone the 2. heat treating step, the direction in which stretching initially occurs is determined to some extent and stretching in the direction that extrusion is performed is common. However, stretching by the heat treating and stretching method used in the present invention can be performed in any direction. In particular, with a sheet prepared by using dispersion coating or a sheet prepared with no difference in strength in the MD and CD by the method introduced in Patent Document 6, a porous membrane can be prepared without problems regardless of the direction in which stretching is started.

If heat setting is required in the stretched porous membrane, baking may be performed at the melting point of PTFE to 400° C., preferably 350 to 400° C., and more preferably 350 to 385° C. for 10 to 120 seconds.

In the stretching step for obtaining the PTFE porous membrane, a discontinuous stretching method of discontinuously (batch type) stretching the sheet shaped rolled product subjected to step 2, and a continuous stretching method are used. In the present invention, the PTFE porous membrane can be obtained by appropriately selecting a stretching method or a stretching device in accordance with the target properties of the PTFE porous membrane.

The stretching ratio in the MD and CD of the sheet shaped rolled product subjected to step 2. is less likely to be stretched than a sheet shaped rolled product that has not been heat treated in this manner. Therefore, the stretching ratio in the MD and CD is limited to 5 to 7 times. In addition, while it is not necessary to set the stretching ratio in the MD and CD to the same ratio, the stretching ratio in each direction can be determined in accordance with the purpose.

The method of discontinuously (batch type) stretching is a method of cutting the sheet shaped rolled product heat treated at a temperature above the melting point and then sequentially stretching using a biaxial stretching machine.

In the continuous stretching method, first, the sheet shaped rolled product subjected to step 2. is continuously stretched in the same direction as the extrusion direction (MD) of the sheet shaped rolled product subjected to step 2. using a longitudinal (extrusion direction) stretching device having a plurality of sets of rollers (nip rollers) capable of heating and vertically nipping (pinching). In the case of continuous stretching in the extrusion direction (MD) using a plurality of sets of roller pairs, the speed difference is preferably set to a rotational speed of each set of roller pairs. More specifically, the rotational speed of second and subsequent roller pairs is increased to be faster than the rotational speed of a first roller pair, such that longitudinal stretching is completed. Thus, the stretching ratio is the ratio of the rotational speeds. When three or more roller pairs are used, longitudinal stretching (continuous stretching in the extrusion direction (MD)) is preferably performed by increasing the speed in a direction of travel.

While not limited thereto, the diameter of the rollers is generally approximately 200 mmϕ. Furthermore, a method of continuously stretching in the extrusion direction (MD) using a device having a heating furnace between each set of roller pairs can also be suitably used.

Next, a tenter continuously stretchable in the direction (CD) orthogonal to the extrusion direction is used to continuously grip both sides of the sheet shaped stretched material (continuously stretched in the extrusion direction (MD)) with a chuck, move the chuck while heating, and continuously extend the stretched material in the direction (CD) orthogonal to the extrusion direction to obtain a PTFE porous membrane.

### EXAMPLES

While not strictly limited to the examples, the present invention will be hereinafter described further specifically using these examples.

### Standard Specific Gravity (SSG)

The standard specific gravity of the PTFE was determined according to ASTM D4895.

### Crystal Heat of Fusion

The crystal heat of fusion was determined using a differential scanning calorimeter (Diamond DSC manufactured by PerkinElmer Co., Ltd.).

### 1. PTFE or Modified PTFE

The crystal heat of fusion at 296 to 343° C. was determined when 10 mg of PTFE or modified PTFE having no history of being heated to 250° C. or higher is heated to 365° C. at a rate of 10° C./min, cooled to 330° C. at a rate of −10° C./min, cooled from 330° C. to 305° C. at a rate of −1° C./min, cooled from 305° C. to 245° C. at a rate of −10° C./min, and then heated to 365° C. at a rate of 10° C./min.

### 2. Sheet or Coating Film

ΔH0: A crystal heat of fusion (J/g) between 295 and 360° C. was obtained from a DSC curve obtained by heating a sheet or coating film of PTFE or modified PTFE without a heating history of 250° C. or higher at 360° C. for 20 minutes, and then heating 10 mg of the sheet or coating film cooled at room temperature to 380° C. at a rate of 10° C./min.

ΔH: A crystal heat of fusion (J/g) between 295 and 360° C. when 10 mg of a sheet obtained by heat treating a sheet or coating film comprising polytetrafluoroethylene and/or modified polytetrafluoroethylene, which has not been heat treated at 250° C. or higher, such that the ratio (ΔH/ΔH0) of the crystal melting heat quantities (ΔH0) and (ΔH) is 1.0 to 2.0, is heated to 380° C. at a rate of 10° C./min.

### IPA Bubble Point

A bubble point with isopropyl alcohol (IPA) was measured in accordance with JIS K3832 using Porolux1000 manufactured by MicrotracBEL Corp.

### Tensile Strength and Air Permeability (Gurley Value)

Using a porous membrane sample piece prepared from a PTFE porous membrane obtained under the conditions indicated in Table 1, the tensile strength was measured in accordance with JIS K6251 using a Tensilon RTC1310A manufactured by Orientec Co., Ltd. at 25° C., a chuck interval of 22 mm, and a tensile speed of 200 mm/min. Note that a porous membrane sample piece of MD 50 mm×CD 10 mm was used for the strength in the MD (extrusion direction), and a porous membrane sample piece of MD 50 mm×CD 10 mm was used for the strength in the CD (direction orthogonal to extrusion direction). Furthermore, the MD strength×CD strength are indices of the overall strength of the PTFE porous membrane, and as the value thereof increases, the strength becomes superior.

The air permeability was measured using a Garley Densometer (air permeability tester) manufactured by Toyo Seiki Seisaku-sho, Ltd.

### Ratio of Openings in PTFE Porous Membrane (Surface Opening Ratio), Fiber Diameter

Following the sputter deposition of the PTFE porous membrane with platinum palladium alloy, it was observed under an electron microscope (SU-8000 manufactured by Hitachi High-Tech Corporation).

In the example, a surface structure was observed at 10,000×, and binarization was performed using Image-Pro-Plus image analysis software manufactured by Media Cybernetics, Inc. to calculate the pore opening ratio of the porous membrane.

The fiber diameter was analyzed using Fibermetric in the Phenom™ Pro Suite of ProX tabletop scanning electron microscope software manufactured by Phenom World.

### Film Thickness

A dial thickness gauge manufactured by Peacock was used for measurement.

### Needle Penetration Test (Needle Penetration Strength)

A semicircular needle with a diameter of 1.0 mm and a tip end shaped radius of 0.5 mm as specified in JIS Z1707 was made to penetrate at a testing rate of 50±5 mm/min, and the numerical value (needle penetration strength) obtained by dividing the maximum force (mN) until the needle penetrates by a thickness (μm) of the test piece is measured.

### Polymerization of PTFE Used in Example 1

60 g of paraffin wax, 2300 mL of deionized water, and 12 g of ammonium salt of a fluoromonoether acid (formula: C₃F₇—O—CF(CF₃)COOH), 0.05 g of ammonium salt of fluoropolyether acid (C₃F₇—O—[CF(CF₃)CF₂]ₙ—CF(CF₃)COOH), 0.75 g of succinic acid, 0.026 g of oxalic acid, and 0.01 g of zinc chloride were placed in an autoclave (having a content of 4 liters) made of stainless steel (SUS316) provided with a stirring blade and a jacket for adjusting the temperature, and then the inside of the system was substituted with nitrogen gas three times while heated to 80° C. to remove the oxygen to perform vacuuming. Thereafter, 1 g of perfluorobutylethylene was added, and the internal temperature was maintained at 63° C. while stirring at 111 rpm with an internal pressure of 2.75 MPa using tetrafluoroethylene (TFE).

Next, 510 mL of an aqueous solution in which 40 mg of potassium permanganate (KMnO₄) was dissolved in 2000 mL of water was pumped. At the end of the injection of potassium permanganate, the internal temperature was increased to 85° C., after which TFE was supplied thereto. Stirring was stopped when the consumption of TFE reached 740 g. The gas in the autoclave was released to normal pressure, the vacuum was evacuated, the pressure was returned to normal pressure with nitrogen gas, and the contents were removed to complete the reaction. The solid fraction of the obtained PTFE dispersion was 28%, and the average particle size of primary particles was 0.24 μm. Subsequently, the obtained dispersion was then diluted with water to a solid fraction of 15%, and mechanical stirring was continued at room temperature until agglomerated secondary particles were separated by mechanical stirring.

The obtained agglomerated secondary particles (PTFE powder) were dried at 190° C. for 11 hours to obtain PTFE fine powder. The standard specific gravity (SSG) of the obtained PTFE fine powder and the crystal heat of fusion specified in Patent Document 1 are shown in Table 1.

### Example 1

Using the PTFE fine powder, Isoper M manufactured by Exxon Mobil Corporation in addition to the amounts indicated in Table 1, was mixed for five minutes using a Turbula shaker manufactured by Willy A. Bachofen AG, left to stand at 25° C. for 24 hours, then placed in a cylinder having a diameter of 80 mmϕ of a premolding machine. Subsequently, the upper part of the cylinder was covered with a lid, after which the cylinder was compression molded at room temperature (approximately 15 to 30° C.) at a speed of 50 mm/min to obtain a cylindrical preform. The obtained preform was extruded and molded using an extruder at an RR of 36, a molding temperature of 50° C., and an extrusion speed of 20 mm/min, then extruded using an extrusion die (thickness: 1 mm×width: 140 mm) to obtain a sheet shaped extrudate. The obtained sheet shaped extrudate was cut to a length of 250 mm and rolled a plurality of times in the extrusion direction (MD) and the direction (CD) orthogonal to the extrusion direction using two sets of rollers heated to 50° C. until reaching the thickness after rolling shown in Table 1. Thereafter, the aforementioned Isoper M was evaporated and removed at 200° C. for 15 minutes to obtain a sheet shaped rolled product, which was then cut into a square (120 mm square).

The obtained sheet was secured at four corners to a 1 mm thick aluminum plate (100 mm square) and then heat treated at the temperature and time shown in Table 1 using a high temperature dryer. After heating, cooling was performed at room temperature and then ΔH, ΔH0 were measured. Table 1 shows temperatures and times of the heat treatment.

For stretching, using a biaxial stretching device (EX10-S5 type, manufactured by Toyo Seiki Seisaku-sho, Ltd.), the periphery of the square (90 mm square) rolled product was secured by a chuck (size: 72 mm angle excluding a chuck grip of the biaxial stretching device) and sequentially stretched 2-fold in the MD and CD at a molding temperature of 300° C. at a stretching speed (speed at which the chuck was moved) of 4.32 m/minute, to obtain a stretched material (PTFE porous membrane) (batch type).

Table 1 shows physical properties of the obtained PTFE porous membrane.

Furthermore, Table 1 shows a heat of fusion of the resin under a predetermined condition and ΔH/ΔH0.

### Examples 2 and 3

In Example 2, a PTFE resin 650J manufactured by Chemours-Mitsui Fluoroproducts Co., Ltd. was used, and a sheet was prepared under all the same conditions as in Example 1 except for the heating time shown in Table 1.

In Example 3, a PTFE resin 660J manufactured by Chemours-Mitsui Fluoroproducts Co., Ltd. was used, and a sheet was prepared under all the same conditions as in Example 1 except for the heating time shown in Table 1.

Table 1 shows physical properties of the PTFE porous membranes obtained in Examples 2 and 3.

Furthermore, Table 1 shows a heat of fusion of the resin under a predetermined condition and ΔH/ΔH0.

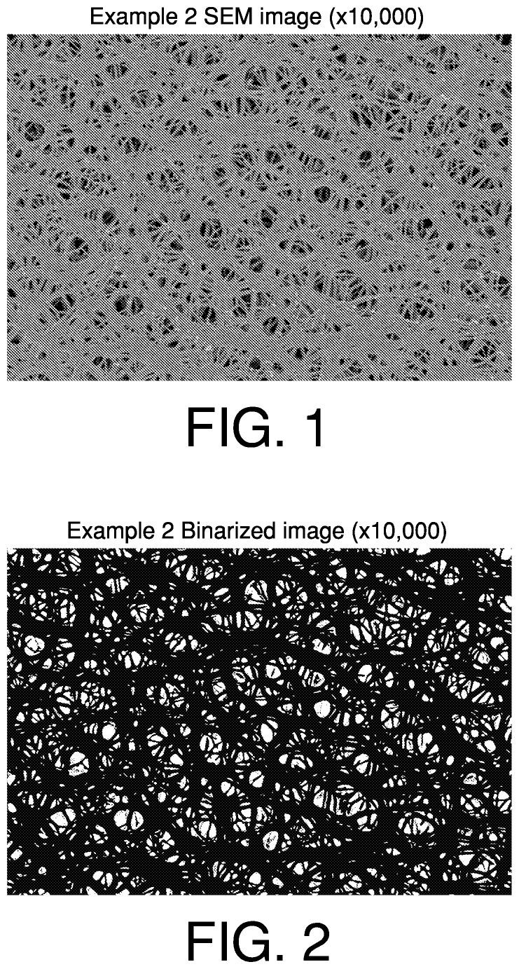

Note that FIG. 1 and FIG. 2 illustrate a photograph of a surface of the PTFE porous membrane obtained in Example 2 by an electron microscope at 10,000× and a photograph obtained by binarizing the image.

### Example 4

Using the PTFE resin 650J manufactured by Chemours-Mitsui Fluoroproducts Co., Ltd. as the resin, a glass plate (10 cm×10 cm) where oil adhering to the surface is removed by a Kimwipe comprising isopropyl alcohol was immersed in a PTFE dispersion (PTFE specific gravity: 2.16, average particle size: 0.25 μm) with a viscosity of 418 cps and a solid fraction concentration of 65 mass %, comprising a solvent dispersing thickening agent (decomposition temperature: less than 380° C.), an acrylic film forming agent (decomposition temperature: less than 380° C.), and a nonionic surfactant (LEOCOL TDN90-80 manufactured by Lion Specialty Chemicals Co., Ltd., decomposition temperature: 300° C. or less), vertically withdrawn at a withdrawing rate of 10 mm/second, dried for 15 minutes at 120° C., and then heat treated for 60 minutes at 380° C. to obtain a 35 μm thick coating film. Thereafter, the coating film is peeled from the glass plate.

The peeled coating film is stretched under the same conditions as Example 1 to obtain a stretched material (PTFE porous membrane). Table 1 shows physical properties of the obtained PTFE porous membrane.

Furthermore, Table 1 shows a heat of fusion of the resin under a predetermined condition and ΔH/ΔH0.

### Example 5

Other than the stretching ratio shown in Table 1, stretching was performed under the same conditions as Example 3 to obtain a stretched material (PTFE porous membrane). Table 1 shows physical properties of the obtained PTFE porous membrane.

Furthermore, Table 1 shows a heat of fusion of the resin under a predetermined condition and ΔH/ΔH0.

### Comparative Example 1

Using the PTFE resin 650J manufactured by Chemours-Mitsui Fluoroproducts Co., Ltd., the sheet shaped rolled material was molded and sequentially stretched 2-fold in the MD and CD at a stretching speed (speed of moving the chuck) of 4.32 m/min at a molding temperature of 300° C. without a heat treating step to obtain a stretched material (PTFE porous membrane) (batch type). Table 1 shows physical properties of the obtained PTFE porous membrane.

Furthermore, Table 1 shows a heat of fusion of the resin under a predetermined condition and ΔH/ΔH0.

### Comparative Example 2

Using the PTFE resin 650J manufactured by Chemours-Mitsui Fluoroproducts Co., Ltd., the sheet shaped rolled material was molded and sequentially stretched 10-fold in the MD and CD at a stretching speed (speed of moving the chuck) of 4.32 m/min at a molding temperature of 300° C. without a heat treating step to obtain a stretched material (batch type). Table 1 shows physical properties of the obtained PTFE porous membrane.

Furthermore, Table 1 shows a heat of fusion of the resin under a predetermined condition and ΔH/ΔH0.

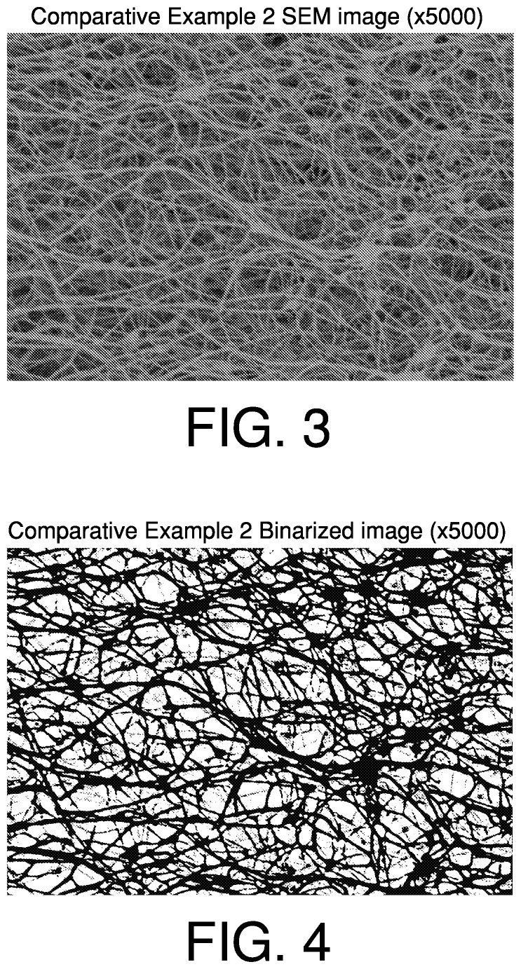

Note that FIGS. 3 and 4 illustrate a photograph of a surface structure of the porous membrane obtained in Comparative Example 2 by an electron microscope at 5000× and a photograph obtained by binarizing the image.

### Comparative Example 3

Other than the heating time shown in Table 1, stretching was performed under the same conditions as Example 1 to obtain a stretched material (PTFE porous membrane). Table 1 shows physical properties of the obtained PTFE porous membrane.

Furthermore, Table 1 shows a heat of fusion of the resin under a predetermined condition and ΔH/ΔH0.

### Comparative Example 4

Other than the heating time shown in Table 1, stretching was performed under the same conditions as Example 3 to obtain a stretched material (PTFE porous membrane). Table 1 shows physical properties of the obtained PTFE porous membrane.

Furthermore, Table 1 shows a heat of fusion of the resin under a predetermined condition and ΔH/ΔH0.

### Comparative Example 5

Other than the heating time shown in Table 1, stretching was performed under the same conditions as Example 3 to obtain a stretched material (PTFE porous membrane). Table 1 shows physical properties of the obtained PTFE porous membrane.

Furthermore, Table 1 shows a heat of fusion of the resin under a predetermined condition and ΔH/ΔH0.

The present invention can provide a porous membrane having a small pore diameter, high needle penetration strength, and a high tensile strength value.

A membrane that is much stronger than a conventional stretched membrane can be prepared by heat treating and then stretching.

TABLE 1

| | | | | | | | | Comparative |
|---|---|---|---|---|---|---|---|---|
| PLFE Porous Membrane | | | Ex. 1 | Ex. 2 | Ex. 3 | Ex. 4 | Ex. 5 | Ex. 1 |
| Manufacturing | Resin | — | Polymerized | 650J | 660J | 650J | 660J | 650J |
| conditions | type | | product | | | | | |
| | | | Modified | PTFE | PTFE | PTFE | PTFE | PTFE |
| | | | PTFE | | | | | |
| | PTFE | | 2.14 | 2.16 | 2.17 | 2.16 | 2.17 | 2.16 |
| | specific | | | | | | | |
| | gravity | | | | | | | |
| | (SSG) | | | | | | | |
| | Heat of | J/g | 16.4 | 23.3 | 26.6 | 23.3 | 26.6 | 23.3 |
| | fusion of | | | | | | | |
| | PTFE | | | | | | | |
| | powder | | | | | | | |
| | Thickness | μm | 200 | 200 | 200 | 35 | 200 | 200 |
| | after | | | | | | | |
| | rolling | | | | | | | |
| | Heating | ° C. | 360 | 360 | 360 | 380 | 360 | N/A (unbaked) |
| | temperature | | | | | | | |
| | Heating | sec | 210 | 240 | 240 | 3600 | 240 | N/A |
| | time | | | | | | | (unbaked) |
| | ΔH | J/g | 17.8 | 23.2 | 24.8 | 24.9 | 24.8 | 65.5 |
| | ΔH0 | J/g | 12.1 | 16.2 | 17.9 | 16.2 | 17.9 | 16.2 |
| | ΔH/ΔH0 | — | 1.47 | 1.43 | 1.39 | 1.54 | 1.39 | 4.04 |
| | Stretching | — | Vertical: 2/ | | | | Vertical: 3/ | Vertical: 2/ |
| | ratio | | Lateral: 2 | | | | Lateral: 2.5 | Lateral: 2 |
| Physical | IPA | kPa | 665.0 | 953.9 | 810.7 | 521.0 | 746.0 | 46.3 |
| Properties | bubble | | | | | | | |
| | point | | | | | | | |
| | Tensile | MPa | 74.8 | 55.1 | 48.8 | 42.0 | 61.3 | 12.7 |
| | strength | | | | | | | |
| | in MD | | | | | | | |
| | Tensile | MPa | 70.5 | 57.7 | 55.4 | 37.1 | 44.1 | 9.7 |
| | strength | | | | | | | |
| | in CD | | | | | | | |
| | Strength | MPa² | 5273.4 | 3179.3 | 2703.5 | 1558.2 | 2703.3 | 123.2 |
| | in MD × | | | | | | | |
| | Strength | | | | | | | |
| | in CD | | | | | | | |
| | Surface | % | 12.7 | 12.0 | 13.6 | 12.2 | 23.2 | 29.1 |
| | porosity | | | | | | | |
| | Fiber | nm | 373 | 382 | 348 | 378 | 410 | 218 |
| | diameter | | | | | | | |
| | Film | μm | 56.6 | 66.8 | 60.4 | 13.0 | 53.9 | 195.0 |
| | thickness | | | | | | | |
| | Needle | mN/μm | 318 | 214 | 210 | 262 | 200 | 23 |
| | penetration | | | | | | | |
| | strength | | | | | | | |
| | Air | s/100 | 768 | 3012 | 1037 | 295 | 303 | 9 |
| | permeability | ml | | | | | | |
| | (Gurley | | | | | | | |
| | value) | | | | | | | |

| | | | Comparative | Comparative | Comparative | Comparative |
|---|---|---|---|---|---|---|
| PLFE Porous Membrane | | | Ex. 2 | Ex. 3 | Ex. 4 | Ex. 5 |
| Manufacturing | Resin | — | 650J | Polymerized | 660J | 660J |
| conditions | type | | | product | | |
| | | | PTFE | Modified | PTFE | PTFE |
| | | | | PTFE | | |
| | PTFE | | 2.16 | 2.14 | 2.17 | 2.17 |
| | specific | | | | | |
| | gravity | | | | | |
| | (SSG) | | | | | |
| | Heat of | J/g | 23.3 | 16.4 | 26.6 | 26.6 |
| | fusion of | | | | | |
| | PTFE | | | | | |
| | powder | | | | | |
| | Thickness | μm | 200 | 200 | 200 | 200 |
| | after | | | | | |
| | rolling | | | | | |
| | Heating | ° C. | (unbaked | 360 | 360 | 360 |
| | temperature | | N/A ) | | | |
| | Heating | sec | N/A | 150 | 150 | 180 |
| | time | | (unbaked) | | | |
| | ΔH | J/g | 66.9 | 54.7 | 58.8 | 44.2 |
| | ΔH0 | J/g | 16.2 | 12.1 | 17.9 | 17.9 |
| | ΔH/ΔH0 | — | 4.13 | 4.52 | 3.28 | 2.47 |
| | Stretching | — | Vertical: 10/ | 2/Lateral: | Vertical: 2/ | Vertical: 2/ |
| | ratio | | Lateral: 10 | Vertical: 2 | Lateral: 2 | Lateral: 2 |
| Physical | IPA | kPa | 107.9 | 298.0 | 56.0 | 201.2 |
| Properties | bubble | | | | | |
| | point | | | | | |
| | Tensile | MPa | 29.2 | 26.7 | 8.9 | 26.6 |
| | strength | | | | | |
| | in MD | | | | | |
| | Tensile | MPa | 8.2 | 23.6 | 6.1 | 25.1 |
| | strength | | | | | |
| | in CD | | | | | |
| | Strength | MPa² | 239.4 | 630.1 | 54.3 | 667.7 |
| | in MD × | | | | | |
| | Strength | | | | | |
| | in CD | | | | | |
| | Surface | % | 51.7 | 22.2 | 28.6 | 27.3 |
| | porosity | | | | | |
| | Fiber | nm | 177 | 356 | 308 | 258 |
| | diameter | | | | | |
| | Film | μm | 15.4 | 190.0 | 169.0 | 91.5 |
| | thickness | | | | | |
| | Needle | mN/μm | 45 | 64 | 15 | 59 |
| | penetration | | | | | |
| | strength | | | | | |
| | Air | s/100 | 1 | 210 | 24 | 63 |
| | permeability | ml | | | | |
| | (Gurley | | | | | |
| | value) | | | | | |

### INDUSTRIAL APPLICABILITY

The present invention provides: a porous membrane comprising polytetrafluoroethylene and/or modified polytetrafluoroethylene, which has a small pore diameter, is difficult to break, and is resistant to an external force such as penetration and the like; and a manufacturing method of same.

The present invention can be used as a separator or part of a separator in a fuel cell, capacitor, lithium battery, and the like, and can also be used as a part of a separator for physically separating various positive and negative electrodes, in addition to waterproof sound transmitting applications for communication equipment requiring high water resistance and high strength, filtration applications such as vent filters for automobiles, etching solutions of circuit boards in corrosive liquids, organic solvents, or semiconductor manufacturing applications, and the like, applications such as collecting valuable materials in etching solutions, and the like.

1. A porous membrane comprising polytetrafluoroethylene and/or modified polytetrafluoroethylene, wherein
the bubble point due to isopropyl alcohol in accordance with JIS K3832 is 500 kPa or more,
a numerical value obtained by dividing the maximum force until a needle penetrates by the thickness of a test piece is 200 mN/μm or more, based on a needle penetration strength test in accordance with JIS Z1707,
the percentage of pore opening portions is 10 to 30%, and
the fiber thickness is 250 nm or more.

2. The porous membrane comprising polytetrafluoroethylene and/or modified polytetrafluoroethylene according to claim 1, wherein the polytetrafluoroethylene and/or modified polytetrafluoroethylene has a heat of fusion of less than 32 J/g at 296 to 343° C. obtained by using a differential scanning calorimeter, when the polytetrafluoroethylene and/or modified polytetrafluoroethylene is heated to 365° C. at a rate of 10° C./min, cooled to 330° C. at a rate of −10° C./min, cooled from 330° C. to 305° C. at a rate of −1° C./min, cooled from 305° C. to 245° C. at a rate of −10° C./min, and then heated to 365° C. at a rate of 10° C./min, and wherein
the bubble point is 600 kPa or more, and
the numerical value obtained by dividing the maximum force until a needle penetrates by the thickness of a test piece is 250 mN/μm or more, based on a needle penetration strength test.

3. A method of manufacturing the porous membrane comprising polytetrafluoroethylene and/or modified polytetrafluoroethylene according to claim 1, comprising:
(1) a step of obtaining a sheet or coating film comprising polytetrafluoroethylene and/or modified polytetrafluoroethylene, which has not been heat treated at 250° C. or higher;
(2) a step of securing and heat treating the sheet or coating film such that the ratio (ΔH/ΔH0) of the following crystal melting heat quantities (ΔH) and (ΔH0) is 1.0 to 2.0;
(Where
ΔH0 is a crystal heat of fusion between 295 and 360° C. when the sheet or coating film comprising polytetrafluoroethylene and/or modified polytetrafluoroethylene resin, which has not been heat treated at 250° C. or higher, is heated for 20 minutes at 360° C., and then the sheet or coating film obtained by cooling at room temperature is increased in temperature to 380° C. at a rate of 10° C./min; and
ΔH is a crystal heat of fusion between 295 and 360° C. when the sheet or coating film comprising polytetrafluoroethylene and/or modified polytetrafluoroethylene, which has not been heat treated at 250° C. or higher, is heat treated and then increased in temperature to 380° C. at a rate of 10° C./min); and
(3) a step of stretching the heat-treated sheet or coating film in one direction and then sequentially stretching in a second direction orthogonal to the first direction.

4. The method of manufacturing a porous membrane according to claim 3, wherein the heat treating step (2) is a step of securing and heat treating the sheet or coating film obtained in the aforementioned step (1) such that the ratio (ΔH/ΔH0) of the crystal melting heat quantities (ΔH) and (ΔH0) is 1.2 to 1.8.

5. The method of manufacturing a porous membrane according to claim 3, wherein in the stretching step (3), the sheet heat treated in the heat treating step (2) is stretched in an extrusion direction and then sequentially stretched in an orthogonal direction.

6. The method of manufacturing a porous membrane according to claim 3, wherein the sheet used in the aforementioned step (1) is a sheet obtained by rolling a sheet shaped or bead shaped extrudate obtained mixing by polytetrafluoroethylene and/or modified polytetrafluoroethylene with a hydrocarbon based solvent having a boiling point of 150 to 290° C. and then extruding at RR 35 to 120 and a molding temperature of room temperature to 120° C. using an extruder.

7. The method of manufacturing a porous membrane according to claim 3, wherein the coating film used in the aforementioned step (1) is a coating film obtained by coating a dispersion of polytetrafluoroethylene and/or modified polytetrafluoroethylene with a solid fraction concentration of 5 to 75 mass %, comprising a surfactant, film forming agent, and thickening agent onto a flat plate having a heat resistance of 400° C. or higher such that the thickness after drying is 1 to 50 μm, and then drying for 10 to 20 minutes at 100 to 150° C.
